(19) United States
(12) Patent Application Publication
(10) Pub. No.: US 2023/0032507 A1
(43) Pub. Date: Feb. 2, 2023

(54) STATIONARY DEVICE WITH ENCRYPTED FILE ACCESS FUNCTION AND ACCESS METHOD THEREOF

(71) Applicant: FLH Co., Ltd., Taipei (TW)

(72) Inventors: Hou-Chun LEE, Taipei (TW); Ke-Wei WANG, Taipei (TW); Kuo-Chan HUANG, Taipei (TW)

(21) Appl. No.: 17/670,101

(22) Filed: Feb. 11, 2022

(30) Foreign Application Priority Data
Jul. 29, 2021 (TW) 110127982

(51) Int. Cl. G06F 21/62; H04W 4/80; G06F 21/60

(52) U.S. Cl. CPC G06F 21/6218; H04W 4/80; G06F 21/602

(57) ABSTRACT

A stationary device with an encrypted file access function and access method thereof are provided. The portable electronic device sends an access request of an electronic confidential file to the stationary device through a proximal connection. The stationary device sends an access request to the cloud server through a remote connection. Then the cloud server gives the corresponding access commands and verification commands to the portable electronic device and the stationary device. After the stationary device verifies that the access command matches the verification command through the proximal connection, the portable electronic device is allowed to access the electronic confidential file. The portable electronic device and the stationary device constantly check whether they are still within a certain distance, so as to restrict the user from accessing the electronic confidential file only in specific areas. Thus, the business secrets and national defense secrets are effectively protected.

### CROSS-REFERENCE TO RELATED APPLICATIONS

This application is based upon and claims priority under 35 U.S.C. 119 from Taiwan Patent Application No. 110127982 filed on Jul. 29, 2021, which is hereby specifically incorporated herein by this reference thereto.

### BACKGROUND OF THE INVENTION

### 1. Field of the Invention

The present invention relates to a technology for accessing encrypted files, and particularly to a method for accessing encrypted files through a stationary device.

### 2. Description of the Prior Arts

Traditional physical confidential files can be manually managed to restrict only specific readers from being able to read them in specific places, so as to prevent readers from taking confidential files out of specific places. With the advancement of technology, more and more information is transmitted through electronic media. When the confidential files are transmitted in electronic form, the encryption can be used to restrict the viewers. For example, if an electronic confidential file is locked with a password, and the password is provided to a user who is authorized to view it, the user can use the password to unlock the electronic confidential file and read it; or the user must pass the identity authentication to unlock the electronic confidential file. However, this method only limits the identity of the reader, but not the location of the reader. Especially in today's society where portable electronic devices (such as mobile phones, tablet computers, and notebook computers) are becoming more and more popular, it is hard to guarantee that people have the right to read electronic confidential files in public areas through portable electronic devices. Then the contents of electronic confidential files may be leaked intentionally or unintentionally. For the protection of business secrets of enterprises and state secrets of the government, it undoubtedly increases management risks.

### SUMMARY OF THE INVENTION

To overcome the shortcomings, the present invention provides a stationary device with an encrypted file access function and an access method thereof to mitigate or obviate the aforementioned problems.

A stationary device with an encrypted file access function and access method thereof are provided. The portable electronic device sends an access request of an electronic confidential file to the stationary device through a proximal connection. The stationary device sends an access request to the cloud server through a remote connection. Then the cloud server gives the corresponding access commands and verification commands to the portable electronic device and the stationary device. After the stationary device verifies that the access command matches the verification command through the proximal connection, the portable electronic device is allowed to access the electronic confidential file. The portable electronic device and the stationary device constantly check whether they are still within a certain distance, so as to restrict the user from accessing the electronic confidential file only in specific areas. Thus, the business secrets and national defense secrets are effectively protected.

Other objectives, advantages and novel features of the invention will become more apparent from the following detailed description when taken in conjunction with the accompanying drawings.

### BRIEF DESCRIPTION OF THE DRAWINGS

FIG. 1 is an illustrative view of a stationary device in accordance with the present invention connecting to a portable electronic device and a cloud server;

FIG. 2 is a block diagram of the stationary device in FIG. 1 connecting to the portable electronic device and the cloud server;

FIG. 3 is a flowchart of the stationary device in FIG. 1 connecting to the portable electronic device and the cloud server;

FIG. 4 is an illustrative view of the stationary device in FIG. 1 having the portable electronic device thereon;

FIG. 5 is an illustrative view of the stationary device in FIG. 1 having the portable electronic device departing from the stationary device;

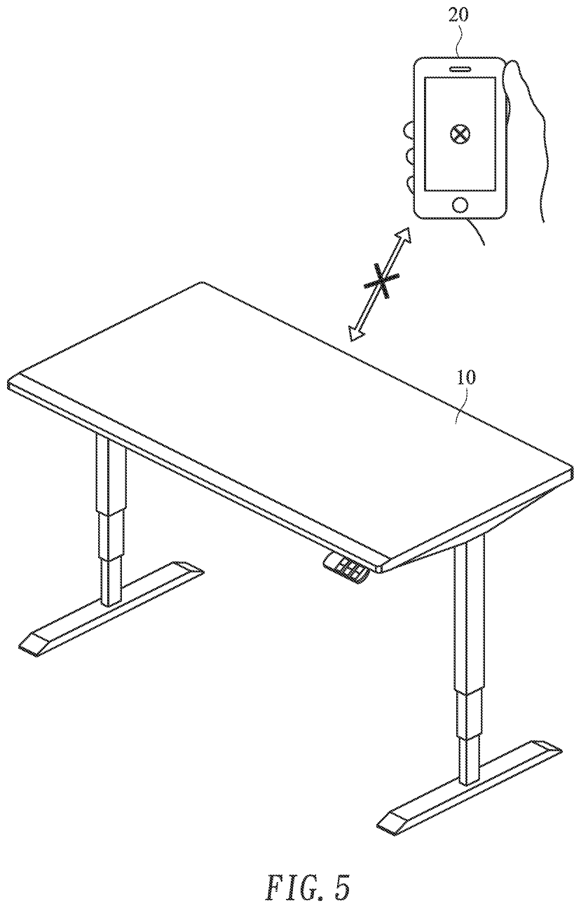

FIG. 6 is a flowchart of an access method in accordance with the present invention; and

FIG. 7 is another flowchart of the stationary device in FIG. 1 connecting to the portable electronic device and the cloud server.

### DETAILED DESCRIPTION OF THE EMBODIMENTS

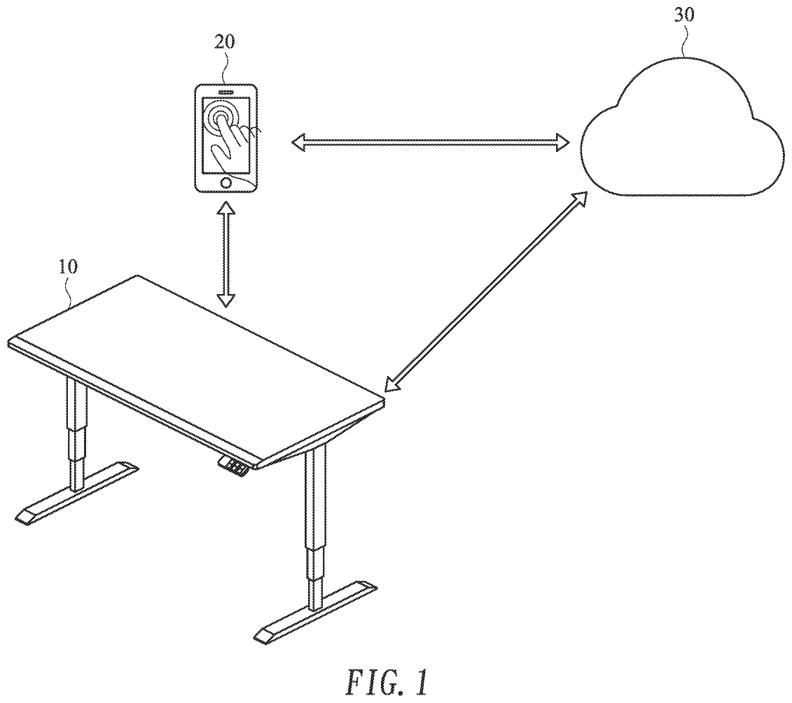

With reference to FIG. 1, a stationary device 10 in accordance with the present invention is generally set in a preset field, and the user cannot easily carry out the device in the preset field, such as desks, office chairs, filing cabinets, safes, etc. The stationary device is connected to a portable electronic device 20 and a cloud server 30 to communicate with each other. The portable electronic device 20 may be a mobile phone, a tablet computer, a notebook computer, etc.

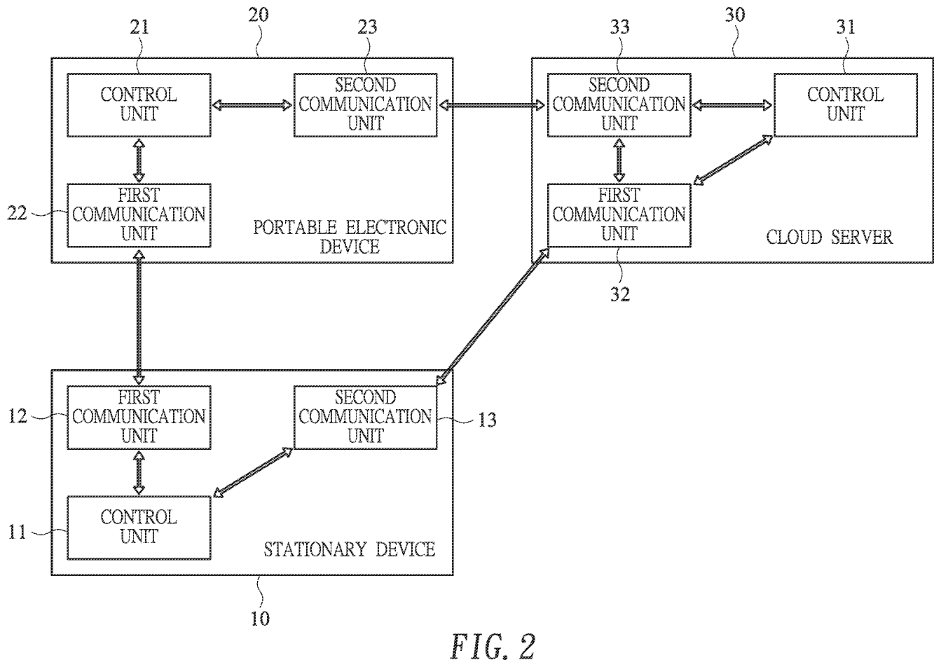

With reference to FIG. 2, the stationary device comprises a control unit 11, a first communication unit 12 and a second communication unit 13. The first communication unit 12 and the second communication unit 13 are electrically connected to the control unit 11. The first communication unit 12 is a near-end wireless communication unit with an effective communication range equal to or less than one meter, such as a near-field communication (NFC) unit. The second communication unit 13 is a remote communication unit with an effective communication range greater than one meter and may be a wireless communication unit (such as Wi-Fi, Bluetooth, 2G, 3G, 4G, 5G or other mobile communication protocols, etc.), or a wired communication unit (by a wired connection to increase the communication range).

The portable electronic device 20 comprises a control unit 21, a first communication unit 22, and a second communication unit 23. The first communication unit 22 and the second communication unit 23 are electrically connected to the control unit 21. The first communication unit 22 is a near-end wireless communication unit with an effective communication range equal to or less than one meter, such as a near-field communication (NFC) unit. The second communication unit 23 is a remote communication unit with an effective communication range greater than one meter and may be a wireless communication unit, such as wireless fidelity (Wi-Fi) communication unit, Bluetooth unit, a second-generation (2G) wireless unit, a third-generation (3G) wireless unit, a fourth-generation (4G) wireless unit, or a fifth-generation (5G) wireless unit or other mobile communication protocols, etc.

The cloud server 30 comprises a control unit 31, a first communication unit 32, and a second communication unit 33. The first communication unit 32 and the second communication unit 33 are electrically connected to the control unit 31. In one embodiment, the first communication unit 32 and the second communication unit 33 are integrated into a single remote wireless communication unit with an effective communication range greater than one meter, such as wireless fidelity (Wi-Fi) communication unit, Bluetooth unit, a second-generation (2G) wireless unit, a third-generation (3G) wireless unit, a fourth-generation (4G) wireless unit, or a fifth-generation (5G) wireless unit or other mobile communication protocols, etc. In another embodiment, the first communication unit 32 is a remote communication unit with an effective communication range greater than one meter and may be a wireless communication unit, such as wireless fidelity (Wi-Fi) communication unit, Bluetooth unit, a second-generation (2G) wireless unit, a third-generation (3G) wireless unit, a fourth-generation (4G) wireless unit, or a fifth-generation (5G) wireless unit or other mobile communication protocols, etc.

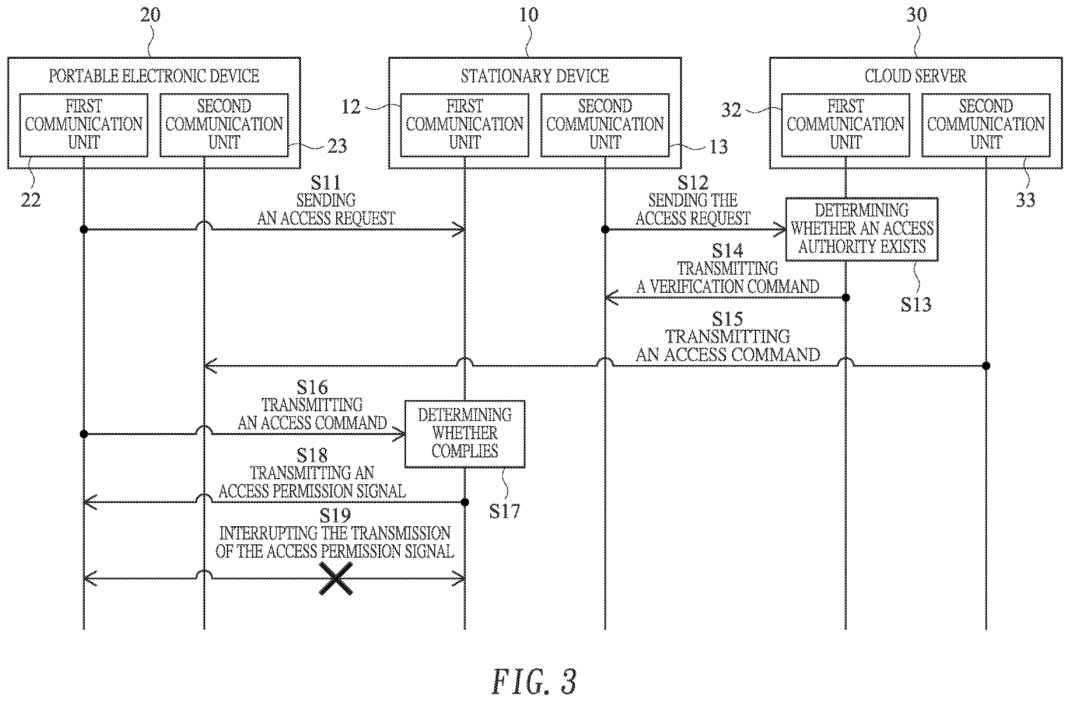

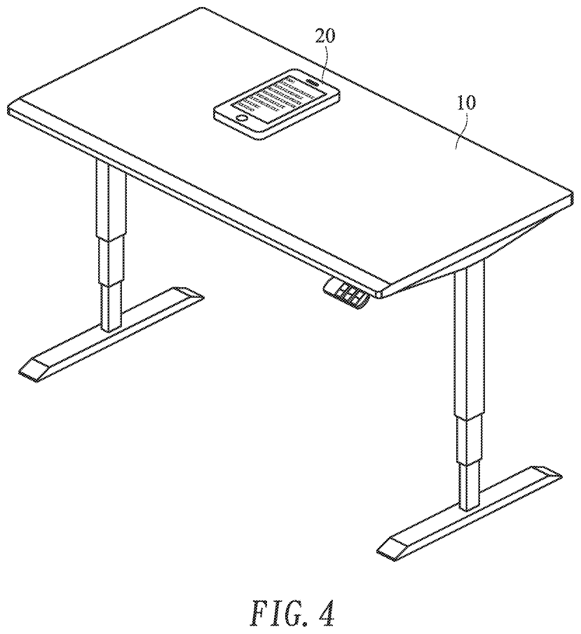

With reference to FIGS. 2 and 3, when the distance between the portable electronic device 20 and the stationary device 10 is less than one meter, the user sends a request for accessing an electronic confidential file through the first communication unit 22 of the portable electronic device 20 to the first communication unit 12 of the stationary device 10 (S11). For example, the portable electronic device 20 as shown in FIG. 4 is placed on the stationary device 10 so that the distance between the portable electronic device 20 and the stationary device 10 is less than one meter. After the stationary device 10 receives the request, the stationary device 10 sends a request to access the electronic confidential file to the first communication unit 32 of the cloud server 30 through the second communication unit 13 of the stationary device 10 (S12). The request may include the identification code of the electronic confidential file and the identification code of the portable electronic device 20 that made the request. The control unit 31 of the cloud server 30 determines whether the portable electronic device 20 has the authority to access the electronic confidential file (S13). If the access authority is confirmed, a verification command is transmitted to the second communication unit 13 of the stationary device 10 through the first communication unit 32 of the cloud server 30 (S14). An access command is also transmitted to the second communication unit 23 of the portable electronic device 20 through the second communication unit 33 of the cloud server 30 (S15). The verification command and the access command may be corresponding passwords, keys, or other signals for interactive verification. After the portable electronic device 20 receives the access command, the portable electronic device 20 transmits the access command to the first communication unit 12 of the stationary device 10 through the first communication unit 22 (S16). The control unit of the stationary device 10 determines whether the access command matches the verification command (S17). If the access command matches the verification command, the stationary device 10 transmits an access permission signal to the first communication unit 22 of the portable electronic device 20 through the first communication unit 12 (S18). Then the user accesses the electronic confidential file on the portable electronic device 20 at this time. The first communication unit 12 of the stationary device 10 and the first communication unit 22 of the portable electronic device 20 must be connected to continuously transmit the access permission signal so that the user can continue to access the electronic confidential file. When the connection between the first communication unit 12 of the stationary device 10 and the first communication unit 22 of the portable electronic device 20 is interrupted, the transmission of the access permission signal is also interrupted (S19). Then the portable electronic device 20 cannot continue to access the electronic confidential file. For example, the portable electronic device 20 is moved away from the stationary device 10 so that the connection between the first communication unit 12 of the stationary device 10 and the first communication unit 22 of the portable electronic device 20 is interrupted.

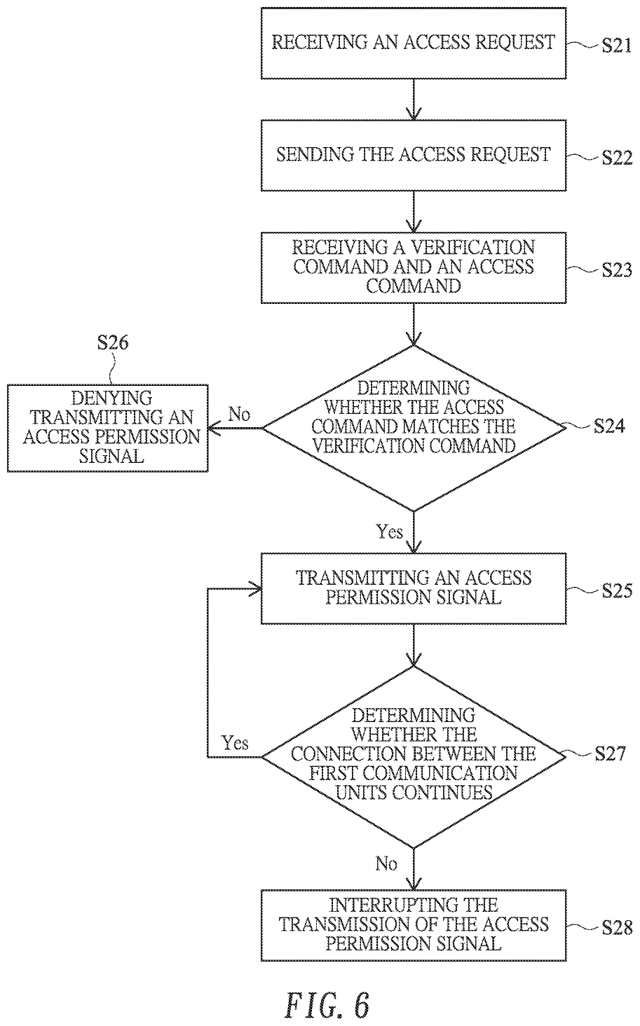

With reference to FIGS. 2 and 6, the control unit 11 of the stationary device 10 executes the following steps:

S21: Receiving an access request to an electronic confidential file from the portable electronic device 20 through the first communication unit 12;

S22: Transmitting an access request to the cloud server 30 through the second communication unit 13, wherein the access request may include the identification code of the electronic confidential file and the identification code of the portable electronic device 20 that made the access request;

S23: Receiving a verification command from the cloud server 30 through the second communication unit 13, and receiving an access command from the portable electronic device 20 through the first communication unit 12;

S24: Determining whether the access command matches the verification command, wherein the determination may be based on whether the passwords, keys or other signals for interactive verification of the access command and the verification command correspond to each other;

S25: If the access command matches the verification command, transmitting an access permission signal to the portable electronic device 20 through the first communication unit 12 to allow the portable electronic device 20 to access the electronic confidential file;

S26: If the access command does not match the verification command, denying transmitting the access permission signal to the portable electronic device 20;

S27: Determining whether the connection between the first communication unit 12 of the stationary device 10 and the first communication unit 22 of the portable electronic device 20 continues; If the connection between the first communication units 12 of the stationary device 10 and the first communication unit 22 of the portable electronic device 20 continues, then executing the step S25;

S28: If the connection between the first communication units 12 of the stationary device 10 and the first communication unit 22 of the portable electronic device 20 is interrupted, interrupting the transmission of the access permission signal to the portable electronic device 20, wherein the portable electronic device 20 cannot continue to access the electronic confidential file.

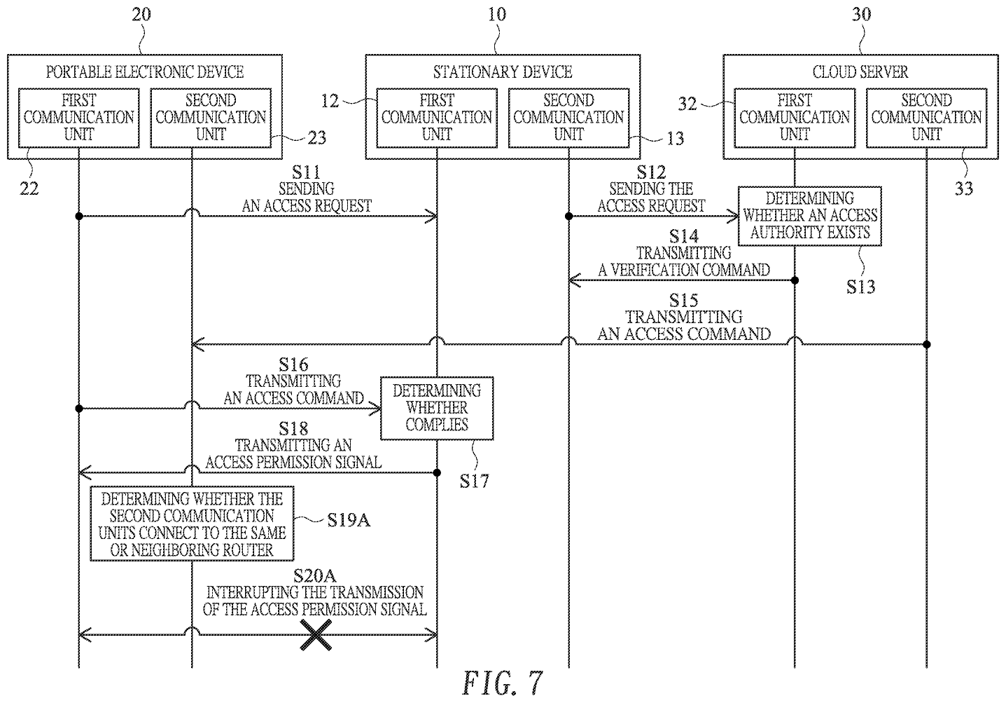

Furthermore, it is determined whether the portable electronic device 20 is far away from the stationary device 10 by checking whether the second communication unit 13 of the stationary device 10 and the second communication unit 23 of the portable electronic device 20 are still in the same environment. With reference to FIG. 7, it is to check whether the second communication unit 13, 23 is still connected to the same or neighboring router (S19A). In one embodiment, it is confirmed whether the Media Access Control (MAC) address of the router connected to the second communication unit 23 of the portable electronic device 20 is the same as the MAC address of the router connected to the second communication unit 13 of the stationary device 10. In another embodiment, it is confirmed whether the MAC address of the router connected to the second communication unit 23 of the portable electronic device 20 and the MAC address of the router connected to the second communication unit 13 of the stationary device 10 are the MAC addresses of the routers in the same environment, i.e. the routers nearby. In this way, it determines whether the portable electronic device 20 is far away from the stationary device 10. If the portable electronic device 20 has been disconnected from the router in the same environment, the stationary device 10 stops transmitting the access permission signal (S20A) so that the portable electronic device 20 cannot continue to access the electronic confidential file. Moreover, the stationary device 10 may also provide the MAC address of the router connected to the stationary device 10 or the MAC address of all routers located in the same environment as the stationary device 10 when transmitting the access command in the step S16. Then the control unit 21 of the portable electronic device 20 continues to check the MAC address of the router connected to the second communication unit 23 of the portable electronic device 20. Once the MAC address of the router connected to the stationary device 10 or the MAC address of all routers located in the same environment as the stationary device 10 is different from the MAC address of the router connected to the second communication unit 23 of the portable electronic device 20, the access permission signal is interrupted (S20A).

In one embodiment, the second communication unit 13 of the stationary device 10 is a wireless communication unit, which is connected to the router through wireless signals. In another embodiment, the second communication unit 13 of the stationary device 10 is a wired communication unit, which is connected to a router through a physical line.

In conclusion, the present invention restricts the portable electronic device 20 to access the electronic confidential files through the near-end connection with the stationary device 10, so as to achieve the purpose of effectively restricting the places where the electronic confidential files can be read. After the portable electronic device 20 starts to read the electronic confidential files, the stationary device 10 continues to confirm whether the portable electronic device 20 maintains a near-end connection or whether it is equal to or less than the same or adjacent router connection range. Therefore, when the portable electronic device 20 has moved away from the stationary device 10 by a certain distance, the portable electronic device 20 can no longer access the electronic confidential files. It ensures that users can only access electronic confidential files in the restricted areas, thereby effectively managing business secrets or national defense secrets.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stationary device for with encrypted file access function comprising:
a control unit;
a first communication unit electrically connecting to the control unit, and being a near-end wireless communication unit with an effective communication range equal to or less than one meter;
a second communication unit electrically connecting to the control unit, and being a remote communication unit with an effective communication range greater than one meter, wherein the control unit executes following steps
a. receiving an access request to an electronic confidential file from the portable electronic device through the first communication unit;
b. transmitting an access request to the cloud server through the second communication unit;
c. receiving a verification command from the cloud server through the second communication unit, and receiving an access command from the portable electronic device through the first communication unit;
d. determining whether the access command matches the verification command;
e. if the access command matches the verification command, transmitting an access permission signal to the portable electronic device through the first communication unit to allow the portable electronic device to access the electronic confidential file;
f. if the access command does not match the verification command, denying to transmitting an access permission signal to the portable electronic device; and
g. determining whether the connection between the first communication unit of the stationary device and a first communication unit of the portable electronic device continues, or whether the second communication unit of the stationary device and the second communication unit of the portable electronic device still connect to the same or neighbor routers; if so, then keeps transmitting the access permission signal; if not, then interrupting the transmission of the access permission signal to the portable electronic device.

2. The stationary device as claimed in claim 1, wherein the first communication unit of the stationary device is a near-field communication (NFC) unit.

3. The stationary device as claimed in claim 1, wherein the second communication unit of the stationary device is a wireless communication unit including Wi-Fi, Bluetooth, 2G, 3G, 4G, or 5G.

4. The stationary device as claimed in claim 2, wherein the second communication unit of the stationary device is a wireless communication unit including one of a wireless fidelity (Wi-Fi) communication unit, Bluetooth unit, a second-generation (2G) wireless unit, a third-generation (3G) wireless unit, a fourth-generation (4G) wireless unit, or a fifth-generation (5G) wireless unit.

5. An access method of an encrypted file comprising steps of:
a. receiving an access request to an electronic confidential file from the portable electronic device by a stationary device through a first communication unit, wherein the first communication unit has an effective communication range equal to or less than one meter;
b. transmitting an access request to the cloud server by the stationary device through a second communication unit, wherein the second communication unit has an effective communication range larger than one meter;
c. receiving a verification command from the cloud server by the stationary device through the second communication unit, and receiving an access command from the portable electronic device by the stationary device through the first communication unit;
d. determining whether the access command matches the verification command by the stationary device;
e. if the access command matches the verification command, transmitting an access permission signal to the portable electronic device by the stationary device through the first communication unit to allow the portable electronic device to access the electronic confidential file;
f. if the access command does not match the verification command, denying to transmit an access permission signal to the portable electronic device by the stationary device; and
g. determining whether the connection between the first communication unit of the stationary device and a first communication unit of the portable electronic device continues by the stationary device, or whether the second communication unit of the stationary device and the second communication unit of the portable electronic device still connect to the same or neighbor routers by the stationary device; if so, then keeps transmitting the access permission signal by the stationary device; if not, then interrupting the transmission of the access permission signal to the portable electronic device by the stationary device.

6. The access method as claimed in claim 5, wherein in the step c, the access command of the portable electronic device is according to an access command transmitted from the cloud server to the portable electronic device.

7. The access method as claimed in claim 6, wherein the cloud server transmits the access command to the portable electronic device through a remote communication unit.

8. The access method as claimed in claim 5, wherein the access request in the step b includes an identification code of the electronic confidential file and an identification code of the portable electronic device.

9. The access method as claimed in claim 6, wherein the access request in the step b includes an identification code of the electronic confidential file and an identification code of the portable electronic device.

10. The access method as claimed in claim 7, wherein the access request in the step b includes an identification code of the electronic confidential file and an identification code of the portable electronic device.

11. The access method as claimed in claim 5, wherein the access command and the verification command include corresponding passwords, keys, or signals for interactive verification.

12. The access method as claimed in claim 6, wherein the access command and the verification command include corresponding passwords, keys, or signals for interactive verification.

13. The access method as claimed in claim 7, wherein the access command and the verification command include corresponding passwords, keys, or signals for interactive verification.

14. The access method as claimed in claim 5, wherein in the step g, the second communication unit of the stationary device wirelessly connects to the router.

15. The access method as claimed in claim 6, wherein in the step g, the second communication unit of the stationary device wirelessly connects to the router.

16. The access method as claimed in claim 7, wherein in the step g, the second communication unit of the stationary device wirelessly connects to the router.

17. The access method as claimed in claim 5, wherein in the step g, the second communication unit of the stationary device connects to the router through a physical wire.

18. The access method as claimed in claim 6, wherein in the step g, the second communication unit of the stationary device connects to the router through a physical wire.

19. The access method as claimed in claim 7, wherein in the step g, the second communication unit of the stationary device connects to the router through a physical wire.
